(19) United States
(12) Patent Application Publication
(10) Pub. No.: US 2024/0343001 A1
(43) Pub. Date: Oct. 17, 2024

(54) FILAMENT WINDING MACHINE WITH A ROTATING SUPPORT HAVING A PLURALITY OF WINDING HEADS

(71) Applicant: MF TECH, Quéven (FR)

(72) Inventor: Flouvat Emmanuel, Argentan (FR)

(21) Appl. No.: 18/294,953

(22) PCT Filed: Jul. 28, 2022
(86) PCT No.: PCT/FR2022/000068

§ 371 Date: Feb. 2, 2024

(30) Foreign Application Priority Data
Aug. 2, 2021 (FR) FR2108411

(51) Int. Cl. B29C 70/38; B29C 70/16; B29C 70/32; B29L 31/00

(52) U.S. Cl. CPC B29C 70/382; B29C 70/16; B29C 70/32; B29L 2031/7156

(57) ABSTRACT

A machine for filament winding, in particular on a liner for the manufacture of tanks, comprising a displacement system able to drive a body in rotation around its longitudinal axis (A) and to effect a relative displacement of the body with respect to winding means. The winding means comprise a rotating support, mounted so as to rotate around a rotation axis (B), on which are mounted at least two winding systems, each winding system comprising a winding head associated with storage means, so that, by rotation of said rotating support around its rotation axis (B), each winding system can be displaced into an active position for winding fiber via its winding head, and an inactive position in which an operator can perform maintenance operations.

### CROSS-REFERENCE TO RELATED APPLICATIONS

The present application is a U.S. National Stage application of PCT/FR2022/000068, filed Jul. 28, 2022, which claims priority to French Application Serial No. 2108411, filed Aug. 2, 2021, the disclosures of which are incorporated herein by reference.

### TECHNICAL FIELD

Embodiments of the present invention relate to a filament winding machine for winding at least one continuous fiber onto a body, in particular onto a liner for the manufacture of tank, as well as to a method for manufacturing a fiber-reinforced part comprising the filament winding of at least one continuous fiber onto a body by means of such a machine.

### BACKGROUND

There are known composite tanks for storing pressurized gases, generally comprising a cylindrical central portion and two end portions having decreasing cross-section and rounded towards the outside, classically known as domes. In the case of type IV tanks, the tanks are formed by an inner shell, classically called a liner, defining a sealed storage chamber, and a reinforcing shell, surrounding the liner, which is obtained by filament winding of continuous fibers around the liner, the fibers preferably being pre-impregnated with a resin, generally thermosetting resin, each fiber being formed from a multitude of continuous filaments.

Filament winding is carried out by means of a filament winding machine which typically comprises winding means comprising at least one winding head associated with fiber storage means, and a displacement system able to rotate the liner around its longitudinal axis, and to perform a relative displacement of the liner with respect to the winding means for winding fiber onto said liner.

It is known, notably in patent document DE 10 2010 047 361, such a machine in which the winding means comprise a winding head mounted on a fixed frame so as to rotate around a horizontal axis. The fibers, coming from fiber spools arranged in a creel, are guided in the form of a web towards the winding head, having first passed through an impregnation system consisting of a resin bath. The displacement system comprises a poly-articulated arm-type robot carrying a gripping device at its end. The gripping device comprises a U-shaped support mounted by its base to the robot's wrist, the liner being mounted by its ends between the two arms of the U and driven in rotation by one of its ends by a motor.

This type of machine, with a robot carrying the liner, makes it possible to offer a compact, simple-to-design, low-cost filament winding machine, using standard robots classically used in the automotive sector. The robot makes it easy to load a liner for the filament winding operation, and to easily transfer the reinforced liner obtained after winding to another processing station.

Replacing the fiber spools requires the machine to be stopped, which considerably reduces the machine's production rates.

### SUMMARY

The aim of embodiment of the present invention is to provide a winding machine enabling the manufacture of parts by winding at high production rates.

To this end, embodiments of the present invention proposes a filament winding machine for winding at least one continuous fiber onto a body having a main longitudinal axis, said machine comprising
winding means comprising at least one winding head associated with fiber storage means, and
a displacement system able to rotate a body around its longitudinal axis and to perform a relative displacement of the body with respect to the winding means for winding fiber onto said body,
characterized in that the winding means comprise a rotating support or carousel, mounted rotatable around a rotation axis, on a fixed structure, on which at least two winding systems are mounted, each winding system comprising a winding head associated with storage means, so that, by rotation of said rotating support around its rotation axis, each winding system can be displaced into an active position for winding fiber by its winding head and an inactive position in which an operator can perform maintenance operations.

According to the invention, the winding machine comprises a carousel carrying several winding systems, so that when one winding system is in use for winding operations, maintenance operations, in particular fiber spool changes, can be carried out in masked time on the other winding system(s). The machine according to the invention thus makes it possible to achieve high production rates. The machine according to the invention is particularly advantageous for the production of high-pressure tanks, with a body constituting the liner of the tank.

According to an embodiment, the rotating support is mounted so that it can rotate around a vertical axis of rotation.

According to an embodiment, the rotating support comprises n winding systems, n being an integer greater than or equal to 2, the winding systems being arranged on the rotating support at a regular angular spacing equal to 360°/n.

According to an embodiment, said rotating support carries two winding systems, each movable between an active position and an inactive position, the maneuvering of each winding system between its two positions being achieved by a 180° and/or −180° rotation of the rotating support around its rotation axis between two positions, a first position in which the first winding system and the second winding system are respectively in the active position and in the inactive position, and a second position in which the first winding system and the second winding system are respectively in the inactive position and in the active position.

According to an embodiment, said rotating support carries a first, second and third winding system, each movable between an active position and two inactive positions, the maneuvering of each winding system between its three positions being achieved by +120° and/or −120° rotations of the rotating support around its rotation axis, between three positions
a first position in which the first, second and third winding systems are respectively in an active position, a second inactive position and a first inactive position;
a second position in which the first, second and third winding systems are respectively in a first inactive position, an active position and a second active position,
a third position in which the first, second and third winding systems are respectively in a second inactive position, a first inactive position, and an active position, at least one of the two inactive positions of each winding system, preferably both inactive positions, correspond to maintenance positions in which an operator can perform maintenance operations.

In another embodiment, the rotating support is mounted rotatable around a horizontal rotation axis.

According to an embodiment, each winding head comprises a guide member, such as an eye or one or more rollers or pulleys, preferably pivotally mounted on said rotating support around a rotation axis, preferably a horizontal rotation axis, each winding system comprising a motor able to pivot its guide member around its rotation axis.

According to an embodiment, the storage means of each winding system comprise mandrels mounted on a support structure, each mandrel being able to carry a fiber spool, and is associated with a tension regulation system, each winding system comprising guide means able to guide the fibers from the mandrels towards the winding head to form a web of fibers at the head.

According to an embodiment, each winding system comprises several winding heads, for example two or three winding heads, each associated with fiber storage means, for example arranged one above the other with the rotation axis arranged in the same vertical plane, the machine then preferably comprising a displacement system able to drive in rotation several bodies, the number of which corresponds to the number of winding heads of each winding system, and to perform a relative displacement of the bodies with respect to the winding means for the simultaneous winding of fiber onto said bodies.

According to an embodiment, the displacement system comprises a first polyarticulated robot and a second polyarticulated robot able to carry said body by its ends, so that the body is mounted rotatably around its longitudinal rotation axis by a first end on the first polyarticulated robot and by a second end on the second polyarticulated robot, at least one of the two polyarticulated robots being equipped with a drive motor for rotating said body around its longitudinal axis. Such a two-robot displacement system makes it possible to carry large bodies, while guaranteeing high displacement speeds and accelerations, and therefore high production rates, as well as reasonable material and installation costs. In addition, such a displacement system enables precise displacement of the body in all three dimensions, resulting in good winding quality. The machine is particularly advantageous for the production of high-pressure tanks, with the body constituting the liner of the tank.

According to an embodiment, each polyarticulated robot is equipped with a mounting device comprising a support base plate assembled to the end wrist of the polyarticulated robot and carrying a clamping chuck, preferably automatic, able to clamp a tubular end of a body, the clamping chuck of the first and/or second polyarticulated robot being connected to a drive motor for rotating the body around its longitudinal axis.

According to an embodiment, at least one of the two chucks is mounted on its base plate with one or more degrees of freedom to avoid any hyperstatic problems when the body is assembled to the two mounting devices.

According to an embodiment, each clamping chuck is mounted on the base plate so that the longitudinal axis of the clamping chuck is arranged perpendicular to the last rotation axis of the wrist of the polyarticulated robot, the mounting devices thus being able to carry a body so that the longitudinal axis of the body is arranged perpendicular to the last axis of the polyarticulated robots. This type of mounting allows optimized three-dimensional displacement of the body for filament winding operations, and for gripping and depositing the body at the opposite side of the winding means from the robot.

According to an embodiment, the clamping chucks of the first and second poly-articulated robots are each connected to a drive motor for rotating the body around its longitudinal axis. In the case of liner, motorization of each clamping chuck prevents twisting of the liner during winding operations.

According to another embodiment, when each winding system comprises several winding heads, as described above, the displacement system is able to carry several bodies, of each polyarticulated robot comprising a base plate with a second panel on which several clamping chucks are mounted one above the other, each body being connected by an end to a clamping chuck of the first polyarticulated robot and to a clamping chuck of the second polyarticulated robot.

According to an embodiment, the displacement system comprises a first polyarticulated robot and a second polyarticulated robot, each formed by a 6-axis type robot. Such 6-axis robots ensure optimum displacement of the body for the winding and for the gripping and depositing of the body at the opposite side of the winding means with respect to the robot.

According to an embodiment, the first polyarticulated robot and the second polyarticulated robot are slidably mounted by their bases on a rail, so that the centre distance between the two robots, in particular between their first vertical rotation axis, can be adapted to the length of the body.

According to an embodiment, the winding means are arranged on a first side of the displacement system, the machine further comprising a loading and unloading bench arranged on the second side of the displacement system which is opposite to the winding means, from which the displacement system is able to grip a body and on which said displacement system is able to deposit a body, said bench preferably being able to receive at least two bodies.

Another object of the present invention is a filament winding installation, characterized in that it comprises several machines as described above, arranged side by side, and a transfer system comprising a polyarticulated robot mounted mobile in translation on a rail, and equipped with a gripping device able to grip a body from the loading and unloading benches of the winding machines and to deposit a body on said loading and unloading benches, said transfer system further preferably comprising an entry bench and an exit bench, said rail being arranged on the side of the loading and unloading benches of the winding machines which is opposite to the displacement systems of the winding machines, Another object of embodiments of the present invention is a method for manufacturing a fiber-reinforced part comprising the filament winding of at least one continuous fiber onto a body, characterized in that the filament winding is carried out by means of a filament winding machine or installation, as described above.

According to one embodiment of the process, for the production of a fiber-reinforced part such as a high-pressure tank, the body constitutes a liner, the fiber-reinforced part being formed of the liner and the fiber winding, the liner preferably comprising a substantially cylindrical central portion and first and second dome-shaped rounded end portions, said liner being equipped at the end with a spindle for its mounting to the ends of the two polyarticulated robots.

In another embodiment, the body constitutes a mandrel, the fiber-reinforced part being formed of the fiber winding.

### BRIEF DESCRIPTION OF THE DRAWINGS

The invention will be better understood, and further goals, details, features and advantages will become clearer in the course of the following detailed explanatory description of two currently preferred particular embodiments of the invention, with reference to the appended schematic drawings, in which:

FIG. 1 is a schematic perspective view of a filament winding machine according to the invention, during the operation of winding fibers onto a body carried by the two robots;

FIG. 2 is a perspective view similar to FIG. 1, during a body unloading operation;

FIG. 3 is a top view of the machine shown in FIG. 1;

FIG. 4 is a side view of the machine shown in FIG. 1;

FIG. 5 is a schematic top view of a installation comprising several filament winding machines;

FIG. 6 is a schematic perspective view of a filament winding machine according to a second embodiment of the invention; and

FIG. 7 and FIG. 8 are a top view and side view, respectively, of the machine shown in FIG. 6.

### DETAILED DESCRIPTION

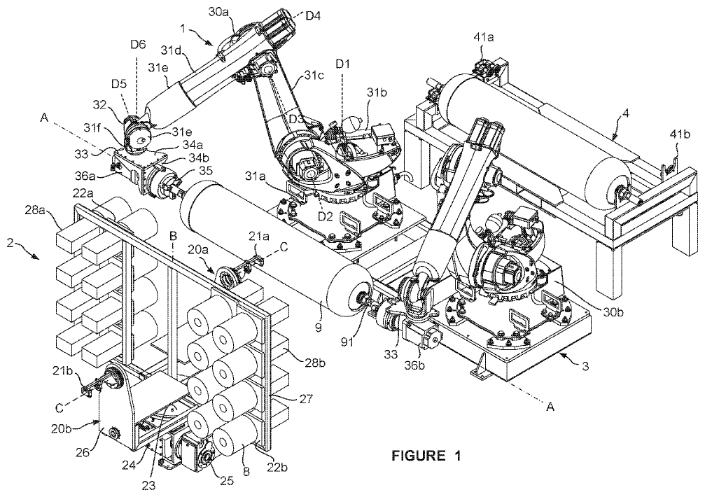

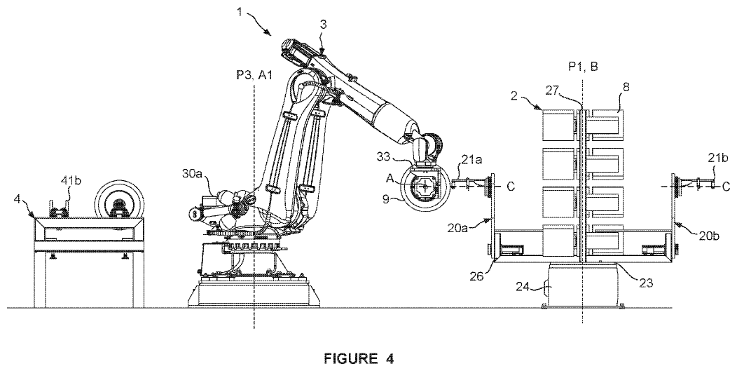

With reference to FIGS. 1 to 4, the filament winding machine 1 according to the invention is used here for winding several fibers in the form of a web onto a body formed by a liner 9 for the production of tanks. The liner has a main longitudinal axis A and comprises a cylindrical central portion and two end domes equipped with mounting spindles 91.

The winding machine comprises winding means 2, a displacement system 3 carrying the liner 9, and a loading and unloading bench or station 4.

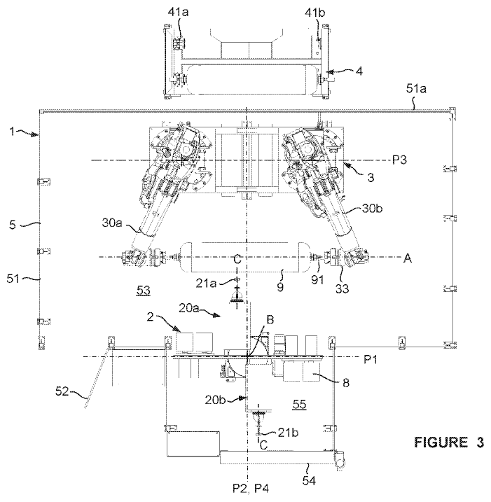

The winding means 2 comprise a first winding system 20a and a second winding system 20b mounted on a rotating support or carousel 23. Carousel 23 is rotatably mounted around a vertical rotation axis B on a floor-mounted frame 24, and can be driven in rotation by a motor 25 controlled by a machine control unit. The two winding systems 20a, 20b are arranged on either side of a first vertical plane P1 (FIG. 3) passing through the axis B. Each winding system comprises a winding head associated with fiber storage means.

The first winding system 20a, arranged on a first side of the plane P1 of the carousel, comprises a first winding head 21a associated with first storage means 22a. The first winding head comprises a guide member formed here by a depositing roller mounted rotatably around a horizontal axis C on a first support 26a fixed to the carousel, said first support 26a extending from plane P1 to space the winding head away from said plane P1. The first storage means 22a comprise mandrels for receiving continuous fiber spools. As the machine is designed to wind a web of 8 fibers, the first storage means comprise eight mandrels. The mandrels are mounted on a support frame 27 fixed to the carousel, substantially in the plane P1. The first winding system also comprises first guide means (not shown), known per se, for guiding the fibers unwound from the spools to the guide member in the form of a web in which the fibers are substantially arranged edge-to-edge. The first winding system comprises a tension regulating system 28a for regulating the tension of each fiber of the web, comprising first tension regulating motors associated with said first mandrels, these first motors being positioned on the second side of the carousel. The first winding head 21a is positioned further away from the plane P1 than the mandrels 22a to provide a clearance between the first head and the plane P1 for guiding the fibers in the form of a web to the guide member.

The machine can be used with resin pre-impregnated fiber spools. When the fiber spools are provided with a support film, the storage means may comprise rewinding mandrels for rewinding the support film onto a roller as the fiber spool is unwound. The machine can also be used with dry fiber spools, in which case the first winding system is equipped with a resin application system for in-line application of resin to the fibers during the winding operation. The impregnation system comprises, for example, a resin impregnation bath arranged in the space between the plane P1 and the first winding head, for a so-called wet winding process.

The second winding system 20b is identical to the first winding system 20a, and comprises a second winding head 21b pivotally mounted around a horizontal axis C on a second support 26b, second storage means 22b comprising second mandrels associated with second tension regulation motors 28b, guide means (not shown), and optionally a resin application system. The second mandrels are mounted on the same support frame 27, the second tension regulation motors 28b being positioned on the first side of the carousel.

In the present embodiment, the first winding head and the second winding head are arranged on either side of a plane P2 passing through axis B, and perpendicular to plane P1, the heads being arranged between plane P2 and their respective storage means.

The displacement system 3 comprises two poly-articulated arms or robots 30a, 30b for carrying the liner, the poly-articulated robots being equipped at the end with a mounting device 33 for mounting the liner by its end spindles 91 to the two poly-articulated robots.

Each poly-articulated robot is of the six-axis robot type, known per se, mounted fixed to the ground, with a mounting device 33 assembled to the end wrist 32 of the poly-articulated robot. With reference to FIG. 1, each polyarticulated robot comprises various sections 31a-31g mounted so as to pivot relative to one another around rotation axis D1-D6, the first section or base 31a being fixed to the ground, the second section 31b being mounted so as to be movable on the base 31a around a vertical axis D1, the end section 31g forming an assembly base plate for assembling the mounting device along the last rotation axis D6, also known as the assembly axis. The last three sections 31e, 31f and 31g form the end wrist 32 of the robot mounted rotatable around axis D4.

The mounting device 33 comprises an L-shaped base plate comprising a first plate 34a by means of which the device is mounted on the wrist 32 and a second plate 34b, perpendicular to the first plate, carrying a clamping chuck 35, for example a lathe chuck, known per se, with three automatic clamping jaws, for example of the pneumatic type, enabling the spindle of a liner to be clamped and unclamped automatically. The clamping chuck mounted on the second plate has a chuck axis perpendicular to the last axis D6 of the robot. The clamping chuck 35 is connected to a drive motor 36a, 36b, located under the first plate 34a of the base plate and controlled by the machine control unit, for rotating the liner around its axis A. Preferably, the first robot 30a comprises a first master drive motor, controlled by the control unit, and the second robot 30b comprises a second slave drive motor, synchronized with the master drive motor.

The two poly-articulated robots are fixed to the floor, one next to the other. With reference to FIG. 3, the carousel 23 carrying the two winding systems is arranged on a first side of the plane P3 passing through the first axis D1 of the robots. In this embodiment, the axis B is located in the median vertical plane P4 which is at an equidistance from axis D1, and is perpendicular to plane P3.

The loading and unloading bench 4 is positioned opposite the carousel with respect to the two poly-articulated robots, on the second side of plane P3. The bench comprises a support structure laid on or fixed to the floor and can receive two liners, with the axis B of the liners arranged parallel to plane P3, the support structure comprising two receiving systems 41a, 41b for each liner, onto which a liner can be placed by its end spindles.

The carousel can be displaced between two positions by a rotation of +180° or −180° around its axis B. In a first position of the carousel illustrated in FIGS. 1, 3 and 4, the first winding system 20a is in an active position, its head can be used for filament winding operations on a liner carried by the two poly-articulated robots. The second winding system 20b is in an inactive position corresponding to a maintenance position. In this position of the carousel, plane P1 is parallel to plane P3, with planes P2 and P4 coinciding.

The winding operation is carried out by the machine control unit, which drives the two poly-articulated robots along programmed paths to displace the liner relative to the winding head 20a, as well as the drive motors 36a, 36b for rotating the liner around its axis A, and the motor for rotating the head 20a around its rotation axis.

During winding operations with the first winding system, an operator can carry out maintenance operations in complete safety on the second winding system in the maintenance position. In particular, the operator can replace the spools of the second winding system, and pass the fibers of the new spools through the guide means to the guide member. The operator can also carry out cleaning and/or replacement operations on the rolls and/or rollers of the second head and/or the guide means, and/or operations on the resin application system.

When it is necessary to change the spools of the first winding system, the carousel is moved to its second position, by rotating it over 180° around its axis C, by driving motor 25 via the machine control unit. In this second position, the second winding system 20b is in the active position to enable winding operations to be carried out via its winding head 21b, while the first winding system is in the maintenance position for maintenance operations, in particular changing spools.

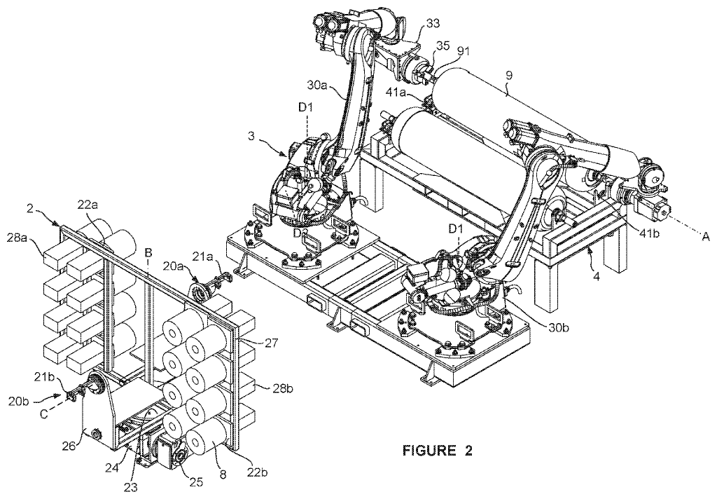

At the end of the liner filament winding operation, the liner is displaced by the two poly-articulated robots on the side of the plane P3 opposite the winding system, to deposit the liner on the receiving systems of the bench as shown in FIG. 2. The automatic clamping chucks 35 of the mounting devices are then controlled to release the spindles, and the poly-articulated robots are controlled to move the clamping chucks in an outward translation movement, parallel to the axis A of the liner, and thus release the spindles from the clamping chucks 35. The poly-articulated robots can then be controlled to grip a new liner from the bench and tilt it in front of the winding system for a new winding operation.

As shown in FIG. 3, the machine advantageously comprises a safety enclosure 5, comprising a barrier 51 surrounding the poly-articulated robots 30a, 30b and the winding means 2, with a first door 52 for access to a first zone 53 in which are positioned the robots and the winding system in the active position, and a second door 54 for access to a second zone 55 in which is positioned the winding system in the maintenance position. The barrier surrounds the winding means, as close as possible to the support frame, while allowing the carousel to rotate, so that an operator accessing the winding system in the maintenance position in the first zone through the second door cannot access the winding system in the active position in the first zone. The barrier portion 51a between the robots and the bench 4 has a reduced height to allow loading of the liner from the bench and unloading of the liner onto the bench with the robots.

According to another embodiment, the carousel and the poly-articulated robots are arranged on the floor with the axis B offset from plane P4, so that the head of the winding system in the active position is arranged in plane P4, with its rotation axis C arranged in plane P4.

According to another embodiment, the two winding systems are arranged symmetrically on the carousel on either side of the plane P1, with the rotation axis C of the two winding systems coinciding.

According to an embodiment, the two poly-articulated robots are slidably mounted by their bases on a rail, so as to be able to adapt the center-to-center distance between the axis D1 of the robots according to the length of the liners, the center-to-center distance preferably being fixed during the winding operations, by locking the robot bases in position on the rail. Advantageously, the first winding system and the second winding system each comprise an automatic attachment device, enabling the fiber or the web of fibers to be automatically attached to the body without manual intervention at the start of filament winding, and an automatic cutting device, enabling the fiber or the web of fibers to be automatically cut at the end of winding.

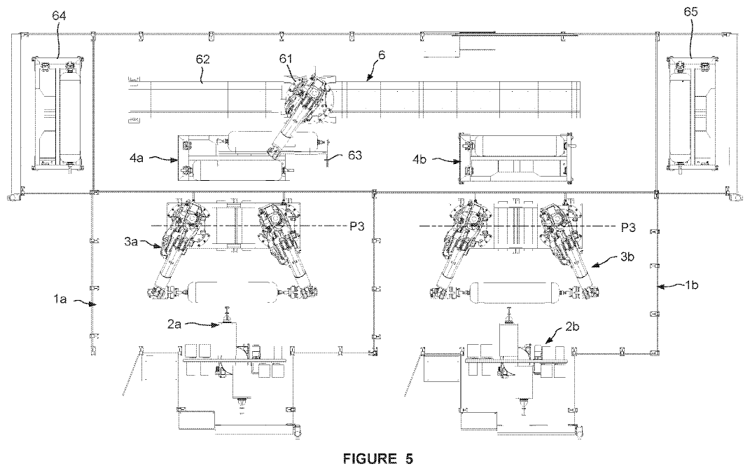

FIG. 5 illustrates a winding installation comprising two winding machines 1a, 1b as described above, each comprising a displacement system 3a, 3b with two robots, winding means 2a, 2b comprising a carousel carrying two winding systems, a loading and unloading bench 4a, 4b. The two machines 1a, 1b are arranged side by side, the planes P3 of the machines being coincident. The installation also includes a transfer system 6, comprising a poly-articulated robot, called a transfer robot 61, of the 6-axis robot type, mounted on a linear rail 62 arranged parallel to the plane P3, on the side of the benches 4a, 4b which is opposite the poly-articulated robots of the winding machines. The transfer robot is fitted on its wrist with a gripping device 63 able to grip liners automatically by their end spindles. The installation also comprises a first entry bench 64 at a first end of the rail, designed to receive liners, and a second exit bench 65, designed to receive the reinforced liners obtained after the filament winding operation. The input and output benches are, for example, identical to the benches 4a, 4b of the winding machines, and can receive two liners. The transfer robot is used to grip liners from the input bench and place them on the winding machine benches, and to grip reinforced liners from the winding machine benches and place them on the output bench. This system makes it possible to efficiently manage the flow of liners and reinforced liners and to achieve high production rates.

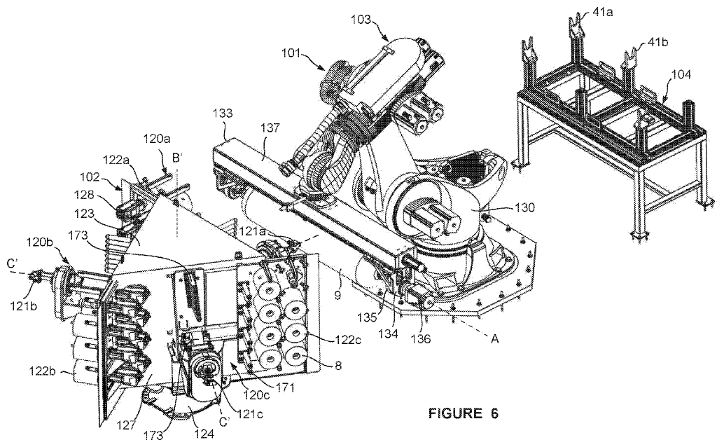

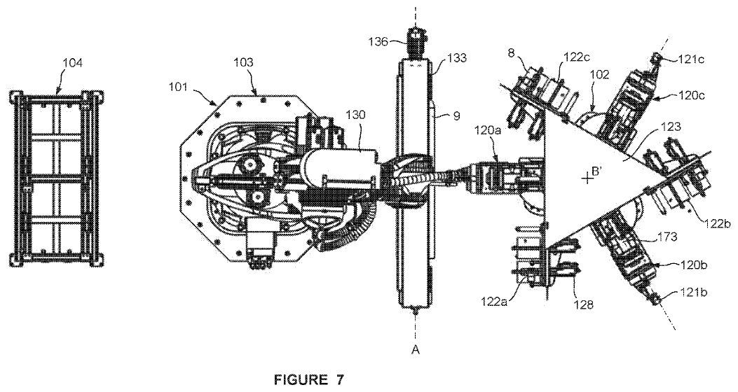

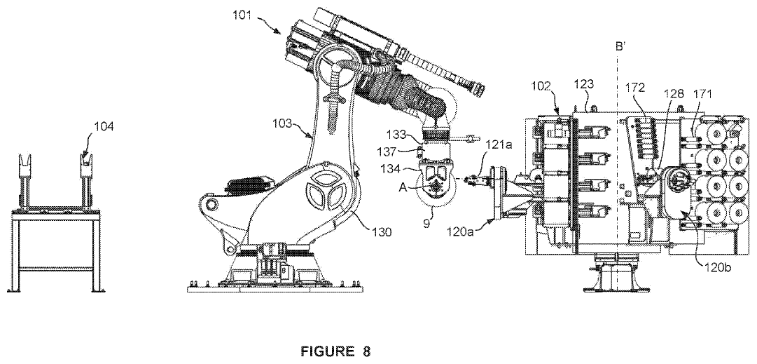

FIGS. 6-8 illustrate a second type of filament winding machine 101 comprising winding means 102, a displacement system 103 carrying the liner 9, and a loading and unloading bench 104.

The winding means 102 comprise three winding systems mounted on a rotating support or carousel 123, namely a first, second and third winding system referenced 120a, 120b and 120c respectively. The carousel 123 is mounted so that it can rotate around a vertical rotation axis B′ on a frame 124 fixed to the floor, and is able to be driven in rotation by a motor (not shown) controlled by a control unit of the machine. The carousel comprises a triangular support structure 127 defining three lateral faces arranged at 120° to each other, with a winding system mounted on each face. Each winding system comprises a winding head 121a-c associated with fiber storage means 122a-c. Each winding head comprises a guide member formed here by several sets of pulleys, an intermediate roller and a final deposit roller, all mounted on an arm, said arm being mounted rotatable around a horizontal axis C′ on a support 126 fixed to the carousel, said support extending outwards from one face, the axis C′ being arranged at 1200 to one another. Each fiber passes over one pulley of each assembly, then over the intermediate roller and the final deposit roller. In the illustrated mode, the winding heads are centered on the faces, and extend radially outwards, with the axis C′ passing through axis B′. In another embodiment, the heads are offset to one side of a lateral face of the support structure. For each winding system, the storage means comprise mandrels for receiving spools of continuous fibers. The mandrels are mounted on a support plate assembled on one side. Each mandrel is associated with a tension control motor 128. Guide means, formed by rollers 171, 172, make it possible to guide the fibers unwound from the spools towards the guide member, the fibers being in the form of a web in which the fibers are substantially arranged edge to edge, at the level of the final deposit roller. Each winding system comprises a resin application system 173 formed by a resin impregnation bath arranged in the space between the plane P1 and the winding head.

The displacement system 103 comprises a poly-articulated robot 130 for carrying the liner 9, the wrist of the poly-articulated robot being equipped at the end with a gripping device 133 for carrying the liner by its end spindles. In this case, the polyarticulated robot is a six-axis robot fixed to the floor by its base. The gripping device 133 comprises a beam 137 connected to the wrist and carrying two L-shaped base plates 134 on the side opposite the wrist. Each base plate comprises a first plate by which it is mounted on the beam and a second plate, perpendicular to the first one, carrying a clamping chuck 135, similar to the one described above for automatically clamping and unclamping the spindle of a liner, the chuck axis being arranged parallel to the beam, perpendicular to the last axis D6 of the robot. The two base plates are spaced apart along the beam. Advantageously, at least one of the base plates, preferably both base plates, are slidably mounted by their first plate on the beam to be able to adapt their spacing to the length of the liner, and to enable automatic gripping and depositing of the liners. The translation movement of each base plate on the beam is ensured by a motor controlled by the machine control unit. One of the two chucks 135 is connected to a drive motor 136 controlled by the machine control unit, to rotate the liner around its axis A. Alternatively, each chuck is connected to a drive motor.

The bench 104, positioned opposite the carousel with respect to the polyarticulated robot, can receive two liners, and comprises for each liner two receiving systems 41a, 41b, formed here of forks, whose positioning on the bench can be adapted to the length of the liners, as illustrated in FIG. 6.

The carousel can be moved between three positions by rotations of +120° or −120° around its axis B′ to displace each displacement system between an active position and two inactive positions. In a first position of the carousel illustrated in FIGS. 6 to 8, the first winding system 120a is in an active position, its head can be used for filament winding operations on a liner carried by the poly-articulated robot. The second winding system 120b and the third winding system 120c are respectively in a second inactive position, and a first inactive position in which maintenance operations, as described above, can be carried out.

A rotation of +120° (clockwise) brings the carousel into a second position in which the first, second and third winding systems are respectively in the first inactive position, in the active position, and in the second inactive position.

A further rotation of +1200 brings the carousel into a third position in which the first, second and third winding systems are in the second inactive position, the first inactive position and the active position respectively.

The winding systems can be used for winding operations one after the other, by successive rotation of 120°, the winding systems being able to be reloaded with new spools when they are positioned in the first inactive position and/or in the second inactive position.

According to another mode of use, the machine is used to wind carbon fiber onto the liner, followed by a final winding of glass fiber. The first winding system and the second winding system are used, for example, to carry out carbon fiber winding operations, while the third system is used for glass fiber winding operations.

Although the invention has been described in connection with various particular embodiments, it is evident that it is by no means limited thereto and that it includes all the technical equivalents of the means described as well as combinations thereof if these fall within the scope of the invention.

1. Filament winding machine for winding at least one continuous fiber onto a body having a main longitudinal axis (A), said machine comprising
winding means comprising at least one winding head associated with fiber storage means, and
a displacement system able to rotate a body around its longitudinal axis (A) and to perform a relative displacement of the body with respect to the winding means for winding fiber onto said body,
wherein the winding means comprise a rotating support, mounted rotatably around a rotation axis, on which are mounted at least two winding systems, each winding system comprising a winding head associated with storage means, so that, by rotation of said rotating support around its rotation axis (B, B′), each winding system can be moved into an active position for fiber winding via its winding head and an inactive position in which an operator can perform maintenance operations.

2. Filament winding machine according to claim 1, wherein the rotating support is mounted rotatably around a vertical rotation axis (B, B′).

3. Machine according to claim 2, wherein said rotating support carries two winding systems, each movable between an active position and an inactive position, the maneuvering of each winding system between its two positions being achieved by a 180° and/or −180° rotation of the rotating support around its rotation axis between two positions.

4. Machine according to claim 1, wherein said rotating support carries a first, second and third winding system, each movable between an active position and two inactive positions, the maneuvering of each winding system between its three positions being achieved by +120° and/or −120° rotations of the rotating support around its rotation axis (B′), between three positions.

5. Machine according to one of claim 4, wherein each winding head comprises a guide member pivotally mounted on said rotating support around a horizontal rotation axis (C, C′), each winding system comprising a motor able to pivot its guide member around its rotation axis.

6. Machine according to one of claim 5, wherein the displacement system comprises a first polyarticulated robot and a second polyarticulated robot able to carry said body by its ends, so that the body is rotatably mounted around its longitudinal rotation axis (A) by a first end to the first polyarticulated robot and by a second end to the second polyarticulated robot, at least one of the two polyarticulated robots being equipped with a drive motor for rotating said body around its longitudinal axis.

7. Machine according to one of claim 1, wherein the winding means are arranged on a first side of the displacement system, the machine further comprising a loading and unloading bench arranged on the second side of the displacement system which is opposite to the winding means, from which the displacement system is able to grip a body and onto which said displacement system is able to deposit a body.

8. Filament winding installation wherein it comprises several machines according to claim 7, arranged side by side, and a transfer system comprising a polyarticulated robot mounted mobile in translation on a rail, and equipped with a gripping device able to grip a body from the loading and unloading benches of the winding machines and to deposit a body on said loading and unloading benches.

9. Method for manufacturing a fiber-reinforced part comprising filament winding of at least one continuous fiber onto a body, wherein the filament winding is carried out by means of a filament winding machine according to an installation according to claim 8.

10. Method according to claim 9, for producing a fiber-reinforced part such as a high-pressure vessel, wherein the body constitutes a liner, the fiber-reinforced part being formed by the liner and the fiber winding.

11. Method for manufacturing a fiber-reinforced part comprising filament winding of at least one continuous fiber onto a body, wherein the filament winding is carried out by means of a filament winding machine according to claim 1.
